(19) United States
(12) Patent Application Publication
(10) Pub. No.: US 2019/0225147 A1
(43) Pub. Date: Jul. 25, 2019

(54) DETECTION OF HAZARD SOUNDS

(71) Applicant: ZF Friedrichshafen AG, Friedrichshafen (DE)

(72) Inventors: Debora Lovison, Friedrichshafen (DE); Florian Ade, Langenargen (DE); Julian Fieres, Schweinfurt (DE); Lucas Hanson, Friedrichshafen (DE); Anja Petrich, Kressbronn-Gohren (DE)

(73) Assignee: ZF Friedrichshafen AG, Friedrichshafen (DE)

(21) Appl. No.: 16/252,353

(22) Filed: Jan. 18, 2019

(30) Foreign Application Priority Data
Jan. 19, 2018 (DE) DE102018200878.7

(51) Int. Cl. B60Q 5/00; B60W 50/16; G06N 3/08; G06N 3/04

(52) U.S. Cl. CPC B60Q 5/006; G06N 3/04; G06N 3/082; B60W 50/16

(57) ABSTRACT

A training system (10) for a vehicle control unit for detecting hazard sounds, in particular accident sounds, that has at least one interface (12) for inputting training data (15) containing an audio signal (16) and a target reaction signal (18) in each case, an evaluation unit (20) that forms an artificial neural network (22) and is configured for forward propagation of the artificial neural network (22) with training data (14) in order to calculate an actual reaction signal (24), and calculating weightings through backward propagation of the target reaction signal (18) in the artificial neural network (22), wherein the weightings are configured to be stored in the vehicle control unit for detecting accident sounds.

### FIELD OF THE INVENTION

The present invention relates to a training system for a vehicle control unit for detecting hazard sounds and a process for training an artificial neural network of a vehicle control unit, a vehicle control unit for detecting hazard sounds in driving situations, a vehicle with a vehicle control unit and a computer program.

### TECHNICAL BACKGROUND

DE 19828409 B4 discloses an accident sound detection circuit.

### SUMMARY OF THE INVENTION

Based on this, the fundamental object of the invention is to further improve the detection of hazard sounds in driving situations. Furthermore, the obtained information should be available to a vehicle control unit.

These problems are solved according to the invention by a training system for a vehicle control unit that has the features of claim 1, and by a process for training an artificial neural network according to claim 8.

Accordingly:

A training system is provided for a vehicle control unit for detecting hazard sounds, in particular accident sounds, that has
at least one interface for inputting training data comprising an audio signal and a target reaction signal in each case,
an evaluation device forming an artificial neural network.

The evaluation device is configured to forward propagate the artificial neural network with training data in order to generate an actual reaction signal, and to calculate an altered topology, in particular weighting, through backward propagation of the target reaction signal in the artificial neural network. The topology is stored in the vehicle control unit for detecting accident sounds.

The invention also provides:

A process for training an artificial neural network of a vehicle control unit that has the following steps:
provision of at least one pair of signals, comprising an audio signal and a target reaction signal;
forward propagation of the artificial neural network with the at least one audio signal;
generating an actual reaction signal based on the forward propagation;
backward propagation of the artificial neural network based on the difference between the actual reaction signal and the target reaction signal.

The backward propagation comprises the identification of an altered topology of the ANN [artificial neural network], in particular weightings, in order to improve the generation of actual reaction signals based on the forward propagation.

Vehicles as set forth in this patent application are motor-driven land vehicles.

An interface is a point of interaction between at least two functional units, where an exchange of logical variables, e.g. data, or physical variables, e.g. electrical signals, takes place, either only in a unidirectional manner, or bidirectionally. The exchange can be analog or digital. The exchange can also be hard wired or wireless.

A control unit is an electronic module for controlling or regulating. Control units are used in the field of passenger cars in all conceivable electronic regions, as well as for controlling machines, systems and other technical processes.

An evaluation unit is a device for processing input information and outputting the results. Electronic circuits such as central processing units or graphic processors are evaluation units.

Computer programs normally comprise a sequence of commands, by means of which the hardware is able to execute a specific process when the program is uploaded, by which specific result is obtained.

An artificial neural network (ANN) is a network of interconnected artificial neurons reproduced in a computing program. The artificial neurons are normally located on various layers. The artificial neural network normally has an input layer and an output layer, the neural outputs of which are the only visible neurons of the artificial neural network. The layers between the input layer and the output layer are normally referred to as hidden layers. An architecture or topology of an artificial neural network is normally first initiated and then trained in a training phase for a special task or numerous tasks.

The term “topology of an ANN” comprises all aspects of the structure of an ANN. These include, e.g. the number of neurons in the ANN, the distribution of the neurons in individual layers of the ANN, the number of layers of an ANN, the networking of neurons and the weighting of the network.

The training of the artificial neural network typically comprises a modification of a weighting of a connection between two artificial neurons of the artificial neural network. The weighting contains information regarding the extent to which a neuron input is taken into account. The training of the artificial neural network can also comprise development of new connections between artificial neurons, deletion of existing connections between artificial neurons, adjustment of threshold values of the artificial neurons, and/or addition or removal of artificial neurons.

One example of an artificial neural network is a shallow artificial neural network (shallow neural network), frequently containing only one single hidden layer between the input layer and the output layer, which is thus easily trained. Another example is a deep artificial neural network (deep neural network), which contains numerous interconnected hidden layers of artificial neurons between the input layer and the output layer. The deep neural network enables an improved detection of patterns and complex connections.

By way of example, the neural network can be a single or multi-layered feedforward neural network or a recurrent neural network. Feedforward neural networks have neurons that are only forward propagated, i.e. a neuron is only propagated from higher layers.

A recurrent neural network has neurons connected bidirectionally, i.e. a neuron is also propagated by lower layers. As a result, in a later running of the ANN, information from an earlier running can be taken into account, by means of which a memory is created.

A training system is a central processing unit on which an ANN is trained.

The training data in this application are pairs of data comprising input data that are to be processed by the ANN, and target results obtained from the ANN. The ANN is modified during the training on the basis of comparisons of target results with the actual results obtained by the ANN, producing a training effect.

The input data with which the ANN is propagated in this application are sounds or audio signals of encoded sounds. The input data may contain hazard sounds, e.g. braking sounds, or typical environmental sounds that are to be distinguished from hazard sounds.

An audio signal is an electrical signal that carries acoustic information.

An actual reaction signal can be derived from actual result data. A target reaction signal can be derived from target result data.

The microphones, which are configured to pick up sounds corresponding to a driving situation, are microphones suitable for use in automobiles, in particular such that they are weather resistant and functionally reliable. These microphones preferably have a filter and/or gain, in order to make them more sensitive to sounds corresponding to the driving situation than to other sounds. There is preferably at least one microphone on each side of the street vehicle, i.e. at the front, back, left and right, such that there is a specific configuration of microphones. The respective microphones are preferably directional microphones.

A directional microphone primarily records the sounds directly in front of it, such that it has a directional characteristic. Sounds from other directions are muted. The recorded sounds are converted to electric signals.

A driving situation is any situation in which a vehicle participates.

The fundamental idea of the invention is to train a vehicle control unit by means of an ANN to detect hazard sounds in a vehicle environment such that a vehicle driver can be reliably warned of impending hazardous situations.

Typical hazard sounds are collision sounds in which a vehicle is involved, braking sounds resulting from a full application of the brake, or braking sounds on slick driving surfaces, so-called squealing.

Although hazardous situations can often be detected visually, there are also situations in which a visual detection of a hazardous situation is not possible, e.g. when the hazardous situation takes place around a curve, in fog, or because the hazardous situation is more audible than visible. By way of example, a full application of the brake can often be heard immediately, whereas a subsequent driver who may not have heard the braking sounds, first realizes later, when he sees it, that a vehicle in front has fully applied the brakes.

This application relates to various vehicles in relation to one another. Vehicles that have a vehicle control unit according to the invention are referred to below as ego-vehicles. Vehicles in front of or behind the ego-vehicle are referred to as second vehicles.

Advantageous embodiments and further developments can be derived from the dependent claims and the description in reference to the drawings.

According to a preferred further development of the invention, the training system has at least one microphone. In particular, training system can have numerous directional microphones. These can form an array, for example. The microphone is configured to pick up sounds corresponding to a driving situation.

As a result, sounds in the surroundings of a vehicle can be recorded in a targeted manner, in that the sounds of the vehicle are muted.

According to a preferred further development of the invention, the audio signal contains acoustic information regarding a braking sound of a second vehicle. Accordingly, hazardous situations for vehicles in front can be recorded, even if these hazardous situations do not result in an accident. In this manner, a full application of the brake by a vehicle in front may be detected early enough to be able to prevent a rear-end collision with the vehicle in front. It is also possible to detect when a vehicle in front is braking on a slick driving surface, e.g. in snow or ice, based on characteristic braking sounds. The information regarding the upcoming, potentially unexpected, slick driving surface can thus be output to the ego-vehicle with a vehicle control unit that detects braking sounds.

Alternatively or additionally, it is advantageous when the audio signal contains information regarding a collision of a second vehicle with another object. A collision can occur, for example, between numerous vehicles, a vehicle and a person, or a vehicle and an inanimate object, e.g. a guardrail.

According to a further development of the invention, the target reaction signal of the training data contains a warning signal, directed to a driver of the ego-vehicle.

It is advantageous when the warning signal is in the form of a haptic, visual, or audio warning signal. Haptic warning signals can be vibration signals, for example, applied to objects that a driver is in contact with. By way of example, a vibration signal can be applied to a steering wheel or a portion of a vehicle seat. Alternatively or additionally, the warning signal can be a visual signal displayed on a screen, e.g. a heads-up display. Audio warning signals, i.e. tones, are also conceivable.

It is also advantageous when the target reaction signal contains two warning signals, wherein a first warning signal is directed toward the driver of the ego vehicle. A second warning signal can be directed at a driver in a trailing second vehicle, e.g. in that a visual warning is displayed on the back end of the ego vehicle. Rear windows or body parts of the ego vehicle can conceivably be used for the display surfaces for warning a driver in a trailing vehicle.

As a result, it is possible to avoid surprising the driver in a trailing vehicle with a full application of the brake by the driver of the ego-vehicle, which would result in a rear-end collision.

Furthermore, vehicle control units for detecting hazard sounds with an evaluation unit that has been trained by a process according to the invention, are advantageous. Moreover, such a vehicle control unit for detecting hazard sounds in driving situations has at least one microphone, preferably a directional microphone, for recording the sounds of driving situations.

Furthermore, vehicles with such a vehicle control unit are advantageous when the vehicle has at least one means of outputting a warning signal. The means can be a display screen, a projector that projects a visual signal onto a windshield or rear window, a vibrator for vibrating a steering wheel, or a loudspeaker.

Furthermore, computer programs that have programming code for executing the process according to the invention for training an artificial neural network are also advantageous.

The computer program according to one embodiment of the invention executes steps of a process according to the description above, when the computer program runs on a computer, in particular a vehicle computer. When the relevant program is used on a computer, the computer program affects this, specifically the mechanical learning, or training, of an ANN to detect hazard sounds.

### CONTENTS OF THE DRAWINGS

The present invention shall be explained in greater detail below based on the schematic figures in the drawings. Therein:

FIG. 1 shows a block diagram of an embodiment of the invention;

FIG. 2 shows a block diagram of an embodiment of the invention.

The drawings are intended to further explain the embodiments of the invention. They illustrate embodiments, and serve to explain the principles and concepts of the invention in conjunction with the description. Other embodiments and many of the specified advantages can be derived from the drawings. The elements of the drawings are not necessarily drawn to scale.

If not otherwise specified, elements that are identical, functionally identical, or that have the same effect are indicated by the same reference symbols in the figures.

### DESCRIPTION OF EXEMPLARY EMBODIMENTS

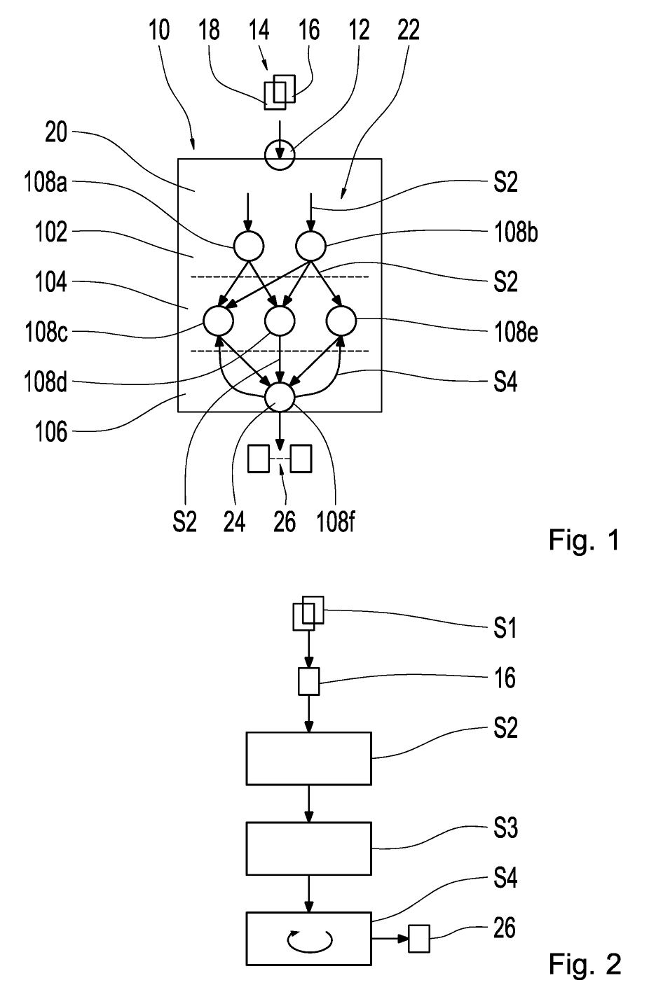

FIG. 1 shows a block diagram of a training system 10 according to one exemplary embodiment of the invention. The training system 10 comprises an interface 12 and an evaluation unit 20 with an ANN 22. The ANN 22 comprises numerous neurons, indicated in a simplified manner by 108a-f. Neurons 108a, b form an input layer 102, neurons 108c, d, e form a hidden layer 104, and neuron 108f forms an output layer 106.

Neurons 108a, b of the input layer 102 are forward propagated with the audio signal 16 via the interface 12. The audio signal 16 is weighted in the neurons 108a, b of the input layer with initial weightings. It may be the case thereby that the audio signal 16 is divided into numerous signal components, and the signal components are weighted. It may also be the case that one or more functions are applied to the weighted input data. The evaluation of the function forms the output value of a neuron 108a, b, which are output to the neurons 108c, d, e of the underlying layer, thus the hidden layer 104, as input values. The hidden layer 104 may contain numerous layers.

As with the input layer 102, the input values that are output to the neurons 108c, d, e of the hidden layer are weighted and one or more functions are applied to the weighted input values. The evaluation of the functions applied to the weighted input values forms the output values of the neurons 108c, d, e. These output values are input to the neurons of the output layer 106 as input values. In FIG. 1, the neurons of the output layer 106 are shown as a neuron 108f, by way of example. The neuron 108f calculates an output value from the input values that are input by the neurons 108c, d, e of the hidden layer 104 by weighting the input values and using one or more functions on the weighted input values. An actual reaction signal 24 can be derived from this output value. This sequence is also referred to as forward propagation of an ANN.

In a next step, the actual reaction signal 24 is compared with the target reaction signal 18, output to the evaluation unit 20 via the interface 12.

In the next step, the topology of the individual layers 102, 104, 106 of the ANN 22 is modified such that the ANN 22 calculates the target reaction signal 18 for the output audio signal 16. The adaptation of the topology 26 can comprise a modification of the weighting, the addition of connections between neurons, the removal of connections between neurons, and/or the modification of functions applied to the weighted input values. This sequence is also referred to as backward propagation of an ANN.

FIG. 2 shows a block diagram of a process for training an ANN according to an embodiment of the invention. The process comprises steps S1-S4.

A pair of signals comprising an audio signal 16 and a target reaction signal 18 are provided in step S1.

The ANN 22 is forward propagated with the audio signal 16 in step S2.

In step S3, an actual reaction signal 24 is calculated on the basis of the forward propagation in S2.

The artificial neural network 22 is backward propagated in step S4, based on the difference between the actual reaction signal 24 and the target reaction signal 18. A modified topology 26 of the ANN, in particular the weighting, is calculated thereby, in order to improve the calculation of actual reaction signals based on the forward propagation.

### REFERENCE SYMBOLS

10 training system
12 interface
14 training data
16 audio signal
18 target reaction signal
20 evaluation unit
22 artificial neural network
24 actual reaction signal
26 topology
102 input layer
104 hidden layer
106 output layer

108a-f neurons

S1-S4 process steps

1. A training system for a vehicle control unit for detecting hazard sounds, in particular accident sounds, that has
at least one interface, for inputting training data containing an audio signal and a target reaction signal in each case,
an evaluation unit forming an artificial neural network, configured for
forward propagation of the artificial neural network with training data in order to calculate actual reaction signals, and
calculating a modified topology of the artificial neural network, in particular weightings, through backward propagation of the target reaction signals in the artificial neural network,
wherein the topology is configured to be stored in the vehicle control unit for detecting hazard sounds.

2. The training system according to claim 1, which comprises at least one microphone, in particular numerous directional microphones, wherein the microphone is configured to pick up sounds corresponding to a driving situation.

3. The training system according to claim 1, wherein the audio signal contains information regarding a braking sound of a vehicle and/or a collision of a vehicle with another object.

4. The training system according to claim 1, wherein a target reaction signal of the training data contains a warning signal directed toward a driver.

5. The training system according to claim 4, wherein the warning signal is a haptic, visual, or audio warning signal.

6. The training system according to claim 4, wherein the target reaction signal contains two warning signals, in particular a first warning signal directed toward the driver of an ego-vehicle, and a second warning signal directed toward the driver of a second vehicle.

7. The training system according to claim 6, wherein the second warning signal is a visual warning signal.

8. A process for training an artificial neural network of a vehicle control unit, which has the following steps:
provision (S1) of at least one pair of signals, comprising an audio signal and a target reaction signal;
forward propagation (S2) of the artificial neural network with the at least one audio signal;
calculating (S3) an actual reaction signal based on the forward propagation (S2);
backward propagation (S4) of the artificial neural network based on a difference between the actual reaction signal and the target reaction signal.

9. A vehicle control unit for detecting hazard sounds in driving situations, in particular accident sounds, comprising at least one microphone, preferably a directional microphone, for picking up driving situation sounds, and an evaluation unit, configured for forward propagation of an artificial neural network with the vehicle situation sounds that has been trained in accordance with the process according to claim 8, in order to assign the driving situation sounds to a reaction signal.

10. A vehicle with a vehicle control unit according to claim 9, wherein the vehicle has at least one means for outputting a warning signal, wherein the means comprises, in particular, a display screen, a projector that projects a visual signal on a windshield and/or rear window, a vibrator for vibrating a steering wheel, and/or a loudspeaker.

11. A computer program that contains program code for executing the process according to claim 8.

12. The training system according to claim 2, wherein the audio signal contains information regarding a braking sound of a vehicle and/or a collision of a vehicle with another object.

13. The training system according to claim 2, wherein a target reaction signal of the training data contains a warning signal directed toward a driver.

14. The training system according to claim 3, wherein a target reaction signal of the training data contains a warning signal directed toward a driver.

15. The training system according to claim 5, wherein the target reaction signal contains two warning signals, in particular a first warning signal directed toward the driver of an ego-vehicle, and a second warning signal directed toward the driver of a second vehicle.
